(19) United States
(12) Patent Application Publication
(10) Pub. No.: US 2012/0231878 A1
(43) Pub. Date: Sep. 13, 2012

(54) SYSTEM AND METHOD FOR GROUP LOTTERY WAGING

(76) Inventor: Joseph F. Angelo, Canfield, OH (US)

(21) Appl. No.: 13/412,137

(22) Filed: Mar. 5, 2012

Related U.S. Application Data
(60) Provisional application No. 61/449,833, filed on Mar. 7, 2011.

(51) Int. Cl. G06Q 20/00

(52) U.S. Cl. 463/27

(57) ABSTRACT

Systems and methods are disclosed herein for pooling the assets of two or more participants and allocating the assets in two or more investments to arrive at desirable overall risk and return attributes for the investments wherein at least one of the investments comprises placing at least one lottery wager. Also, systems and methods are disclosed herein for distributing the assets to the two or more participants.

### CROSS-REFERENCE TO RELATED APPLICATION

This application claims the benefit under 35 U.S.C. §119(e) of U.S. Provisional Patent Application Ser. No. 61/449,833, entitled SYSTEM AND METHOD FOR GROUP LOTTERY WAGING, filed on Mar. 7, 2011, the entire disclosure of which is hereby incorporated by reference herein.

### BACKGROUND

In various circumstances, bettors wishing to place one or more lottery wagers must travel to a local store, for example, having a lottery terminal in order to place such lottery wagers. Ultimately, though, the probability of any such bettor winning a lottery is dependent upon the number of wagers that the bettor places on that lottery. For example, if a bettor places one wager on a lottery, their odds of winning the lottery, or winning probability, is one in a certain number, such as 1:10,000,000, for example. In order for the bettor to increase their winning probability, they must place additional wagers. In the previous example, if a bettor were to place an additional wager, their winning probability may increase to 1:5,000,000, for example. Of course, many lotteries include other prizes in addition to the maximum prize and additional wagers made by a bettor could improve their winning probability of winning such other prizes. Thus, any reference hereinafter to a winning probability or to winning a lottery is inclusive of the maximum prize and any lesser prize, unless otherwise noted.

A notable corollary of the above-discussed arrangement is that the wagers of each bettor do not change or improve the winning probability of the other bettors. Stated another way, in this arrangement, the winning probability of a bettor winning a lottery is independent of the winning probability of another bettor. More to this point, although the presence of other wagers placed on the lottery by other bettors may increase and/or decrease the ultimate monetary value paid out to a winning bettor, such other wagers will not affect the winning probability of any other bettor. Furthermore, in this arrangement, the winning probability of a bettor winning a lottery does not increase after they have placed their wagers. Other games of chance suffer from similar problems. What is needed is an improvement over the foregoing.

### BRIEF DESCRIPTION OF THE FIGURES

The features and advantages of this invention, and the manner of attaining them, will become more apparent and the invention itself will be better understood by reference to the following description of embodiments of the invention taken in conjunction with the accompanying drawings, wherein:

FIG. 1 comprises a flow diagram illustrating several options for purchasing a lottery wager request;

FIG. 2 comprises a flow diagram illustrating systems and methods for purchasing a lottery wager request via a telephone system;

FIG. 3 comprises a flow diagram illustrating systems and methods for purchasing a lottery wager request via an Internet system;

FIG. 4 comprises a flow diagram illustrating systems and methods for purchasing a lottery wager request at a kiosk;

FIG. 5 graphically depicts the information that can be stored within a database of an intermediary;

FIG. 6 depicts a system for operating a plurality of wager request pools, or groups;

FIG. 7 comprises a flow diagram illustrating systems and methods for placing wagers for the wager request pools, or groups;

FIG. 8 comprises a flow diagram illustrating systems and methods for distributing the prizes won by a wager request pool, or group; and

FIG. 9 illustrates an example of a database entry of a wager request.

The exemplifications set out herein illustrate certain embodiments of the invention, in one form, and such exemplifications are not to be construed as limiting the scope of the invention in any manner.

### DETAILED DESCRIPTION

Certain exemplary embodiments will now be described to provide an overall understanding of the principles of the structure, function, and use of the systems and methods disclosed herein. One or more examples of these embodiments are illustrated in the accompanying figures. Those of ordinary skill in the art will understand that the systems and methods specifically described herein and illustrated in the accompanying figures are non-limiting exemplary embodiments. The features illustrated or described in connection with one exemplary embodiment may be combined with the features of other embodiments. Such modifications and variations are intended to be included within the scope of the present invention.

A lottery is a game of chance in which a number of players, or bettors, place wagers and at least one drawing is held in order to determine if one or more of the wagers are eligible for certain prizes. In certain lotteries, bettors select a small group of numbers out of a larger group of numbers and if a player's selection matches some or all of the numbers drawn at random during the drawing, the bettor wins a certain proportion of the prize fund. The prize fund often includes a maximum prize for a wager that matches all of the drawn numbers and lesser prizes for wagers that match less than all of the drawn numbers, for example. While numbers can be used in various lotteries, symbols, for example, can be used in addition to or in lieu of numbers in certain lotteries. As used herein, the term numbers can be inclusive of any suitable alternative or combination of alternatives to numbers, such as symbols, for example. In various embodiments, a drawing comprises the selection of numbers through any suitable method, such as machine-selected numbers, for example. With regard to various lotteries, a bettor can travel to a facility having a lottery terminal and place a wager at the lottery terminal that comprises their selected numbers. As part of placing their wager, they can receive a ticket displaying their selected numbers. In various circumstances, the bettor's selection can be made via a random number generator. In certain lotteries, the bettor can place their bet remotely, such as by mail or over the Internet, and their ticket can be mailed to them. In any event, the bettor may be able to place more than one wager, and purchase more than one ticket, in order to increase their probability of winning a prize from the prize fund.

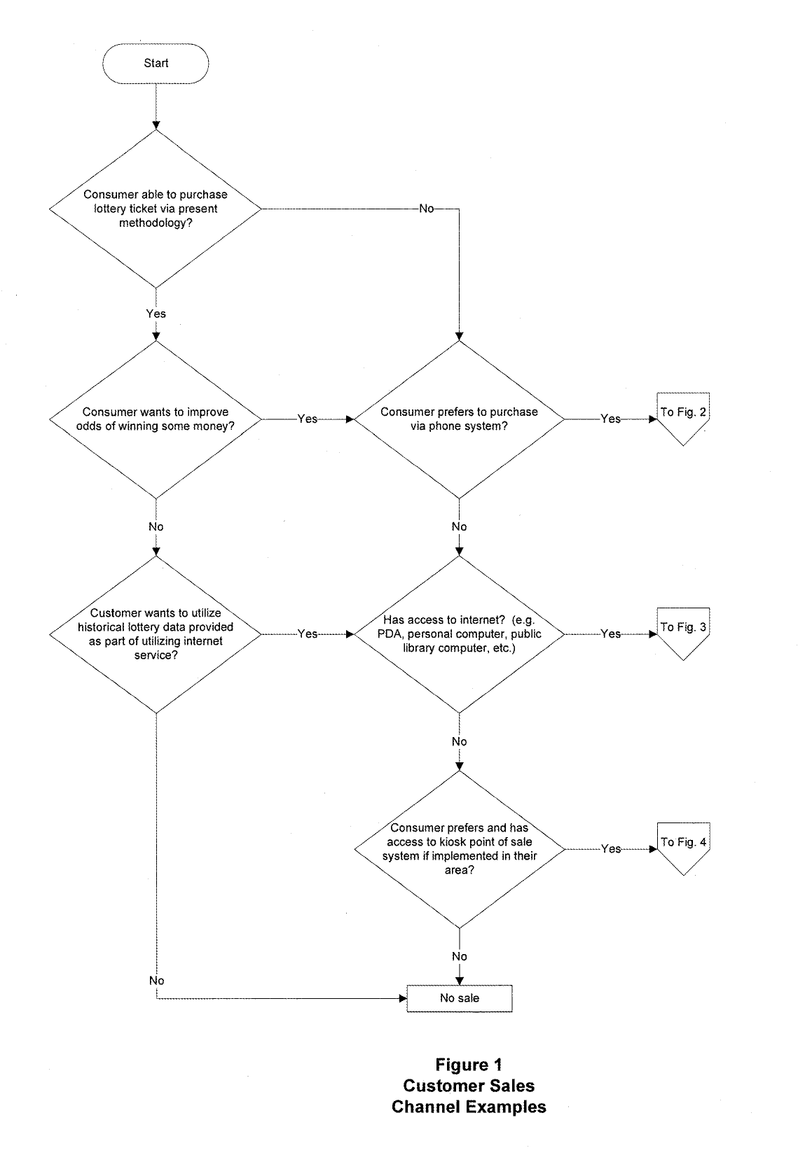

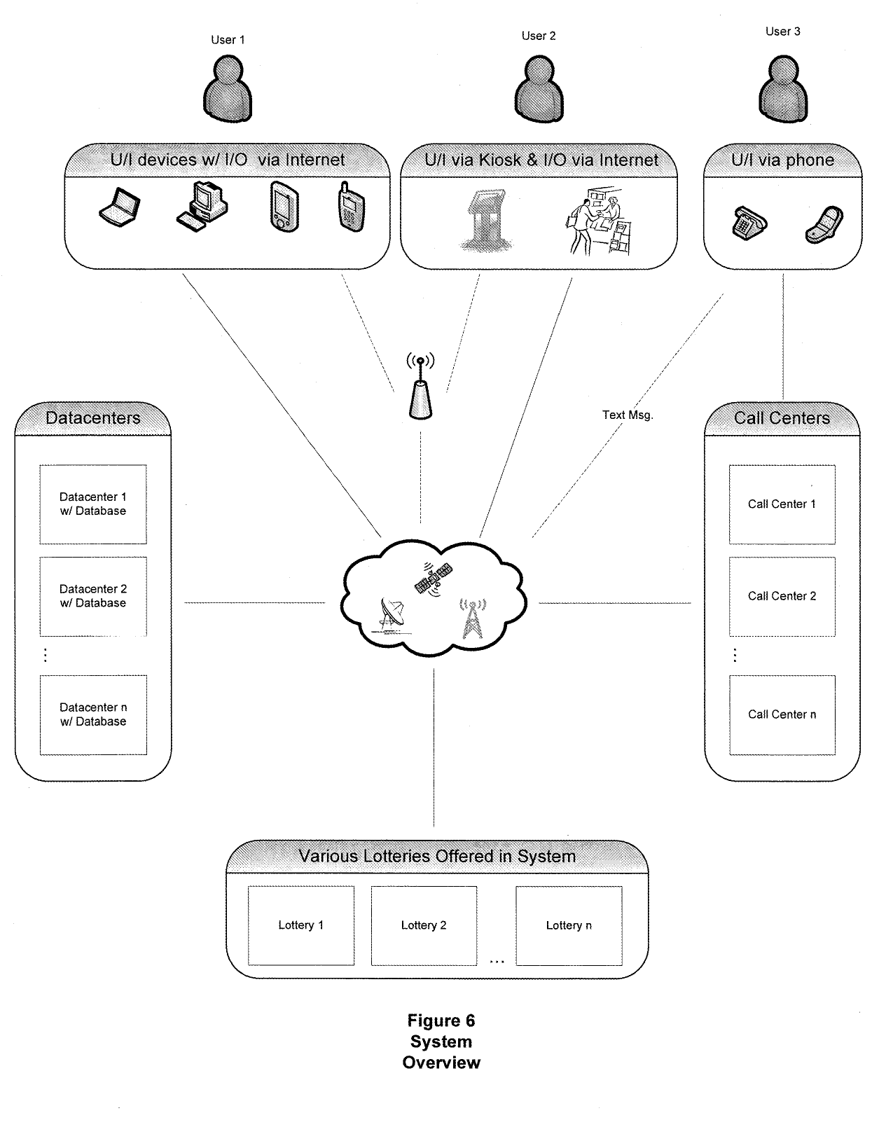

With regard to the above, the winning probability of each bettor is not improved, or otherwise changed, by the placement of wagers by other bettors on the same lottery drawing. In various embodiments disclosed herein, the winning probability of a bettor can be improved by the placement of wagers by other bettors on the same lottery. In at least one such embodiment, the wagers of two or more bettors can be collected and placed into a pool, or group, of wagers wherein, in such circumstances, the presence of the wagers from multiple bettors in the same pool can improve the winning probability of each bettor within the pool. Stated another way, the inclusion of wagers by multiple bettors in the same pool increases the winning probability of the pool of wagers as a whole and, thus, increases the winning probability of each bettor who is participating in the pool. As a result, the winning probability of a pool, or group, is increased for not only a share of the maximum prize, but any lesser prizes as well. In various circumstances, the winning probability of a pool, or group, can be defined as: wr*Σᵢ₌₁ⁿpᵢ, wherein wr comprises the number of wager requests contained within the pool, wherein p comprises the probability of winning a particular prize from the prize pool, and wherein n comprises the number of prizes available in the prize pool. In various circumstances, as a result of the above, the winning probability of a bettor winning some money is improved by participating in a pool, or group. As a result of the above, in various circumstances, a bettor may purchase a portion, or share, of a pool, or group, as opposed to purchasing a ticket, or tickets, for themselves. In various embodiments, as described in greater detail further below and referring generally to FIGS. 1 and 6, an intermediary can receive, collect, and group wager requests from multiple bettors and place wagers with a lottery operator who is operating the lottery.

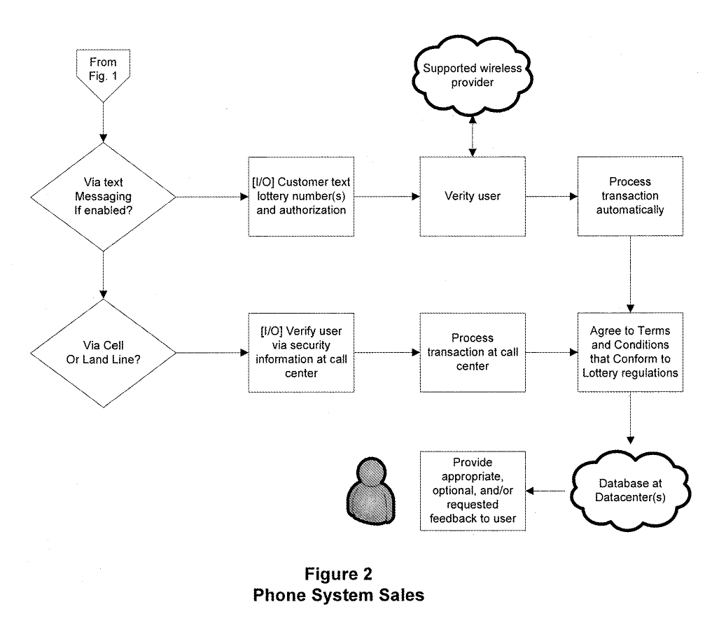

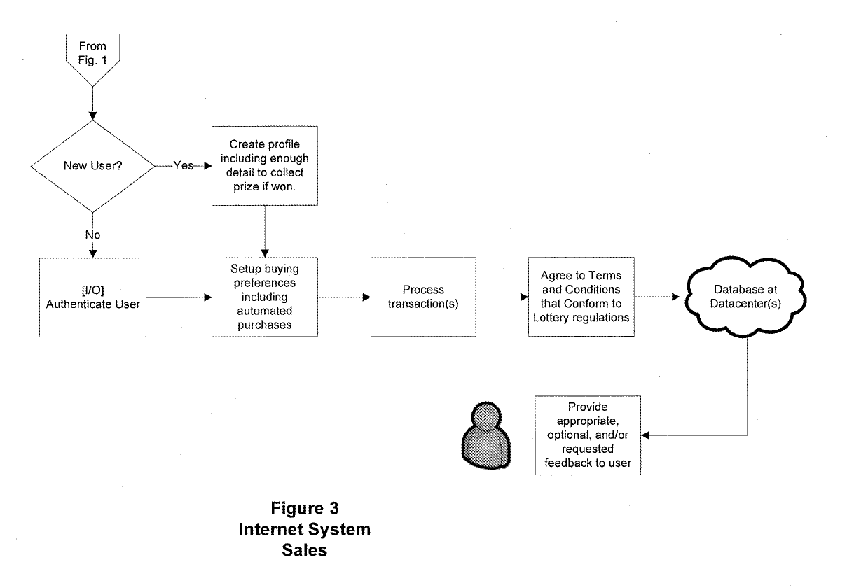

In various embodiments, further to the above, an intermediary can comprise a system for receiving, collecting, and grouping wager requests, i.e., requests from bettors for the intermediary to place a wager on a lottery. In certain embodiments, the intermediary can comprise a computer which can be configured to receive wager requests placed through a user, or bettor, interface. In various embodiments, referring to FIG. 3, the bettor interface can comprise an internet website which can be hosted by any suitable computer, such as a web server, the intermediary computer, and/or any other suitable computer, for example. Web servers, the intermediary computer, and/or any other suitable computer, can be configured to store data and/or deliver documents, such as HTML documents, for example, and/or any other additional content that may be included within a document, such as images and/or JavaScripts, for example. In various embodiments, the bettor interface can be configured to generate a wager request and/or transmit a wager request to the intermediary computer. In certain embodiments, for example, the bettor interface can comprise an intranet connection to the intermediary computer using a network of computers dedicated to operating the intermediary system. In addition to or in lieu of an Internet website, a bettor interface can comprise any other suitable software application, for example. In certain embodiments, referring to FIG. 2, such software applications could comprise a software application for a cellular phone and/or any other suitable wireless device, for example, which can be configured to generate a wager request and/or transmit a wager request to the intermediary computer. In at least one such embodiment, the software application can be configured to generate and/or transmit a wager request via an electronic message, such as an e-mail and/or a text message, for example. In various circumstances, as a result of the above, a bettor can conveniently participate in a lottery in their geographic area and/or a lottery that is outside of their geographic area and/or country, for example.

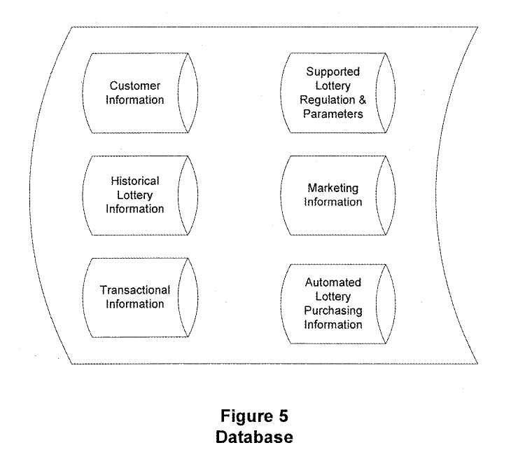

In various embodiments, further to the above, a computer can include any suitable device for implementing the methods and systems described herein. In certain embodiments, a computer can comprise a microprocessor and a memory storage device, such as a hard drive, for example, wherein the microprocessor can be configured to transmit data to and retrieve data from the memory storage device. The computer can comprise operating system software which can allow the intermediary to program, control, and/or direct the microprocessor to perform certain tasks. The computer can also comprise a database stored on the memory storage device, wherein the database, and the information stored in the database, can be accessed and managed by the microprocessor, for example. As described in greater detail below, and referring to FIG. 5, the database can comprise information regarding the pools of wager requests, for example. In certain embodiments, the database, or portions of the database, can reside on different computers. The computer can include any suitable number of input and/or output devices and channels configured to allow bettors, or bettor interfaces, to access and/or communicate with the computer, for example.

In various embodiments, the bettor interface can comprise one or more security features, such as a login feature, for example, which can allow a bettor to access a bettor profile stored in the bettor interface, the web server, the intermediary computer, and/or any other computer, or device, in signal communication with the intermediary computer. A device in signal communication with the intermediary computer can comprise any suitable device that can transmit data to and/or receive data from the intermediary computer by any suitable communication means, such as wireless and/or wired communication, for example. In certain embodiments, the bettor profile can be stored on the bettor's computer, a computer being used by the bettor, the bettor's wireless communications device, a wireless communications device being used by the bettor, and/or a removable media device which is connectable to and/or disconnectable from a computer or wireless communications device, such as a DVD, CD, and/or a memory card, such as a flash memory card, for example. In various embodiments, the bettor profile can comprise certain information regarding the bettor, their previous transactions, or wager requests, with the intermediary, and/or any other suitable information which can be accessed by the bettor. In at least one embodiment, the bettor profile can comprise data, or can access data, regarding a user agreement between the bettor and the intermediary. In various embodiments, the user agreement can define an ongoing legal agreement between the bettor and the intermediary outlining certain risks and obligations of each party. In certain embodiments, a bettor profile can include a set, or sets, of numbers in which a bettor prefers to play. In at least one embodiment, the bettor can enter this information into their bettor profile while, in certain embodiments, the intermediary computer and/or bettor interface, for example, can be configured to study the bettor's history and store repeatedly used sets of numbers, for example.

In various embodiments, as outlined above, the intermediary can collect wager requests from multiple bettors and group the wager requests into one or more wager request pools. In certain embodiments, the intermediary can offer a plurality of pools in which a bettor can selectively place wager requests into one or more of the pools. Each pool can be constructed and arranged such that wager requests placed into the pool will be placed on a particular lottery. In various embodiments, the various pools offered by an intermediary can be placed on different lotteries; for example, the wager requests placed into a first pool can be placed on a first lottery while the wager requests placed into a second pool can be placed on a second lottery. In certain circumstances, the intermediary can offer several pools which will place wagers on the same lottery. In at least one embodiment, the intermediary can offer a pool in which the participation in the pool is open-ended. More particularly, in at least one such embodiment, the intermediary can receive and place wager requests into a wager pool until a certain time deadline has been reached. Upon reaching the time deadline, the intermediary can close the wager request pool and prevent additional wager requests from being placed in the pool. At such point, the number of wager requests within the pool can comprise the wager request pool count. The intermediary can then place a number of wagers equal to the wager request pool count on the lottery designated by or associated with the wager request pool before the lottery drawing is held, or before the appropriate deadline for placing such wagers has been reached.

As outlined above, the intermediary can offer a plurality of wager request pools into which bettors can place one or more wager requests. In various embodiments, the intermediary computer and/or bettor interface can be configured to display information regarding each wager request pool. In at least one embodiment, the bettor interface can access information, or data, contained on the intermediary computer, and/or any other computer, arrange the data, and display the data in a desired manner to the bettor. In at least one such embodiment, the bettor interface can display information for each wager request pool such as, for example, the lottery in which the wager requests will be made, the time deadline, and/or the number of wager requests already collected into the pool. In certain embodiments, the bettor interface can display the number of wager requests within a pool in real-time. In at least one embodiment, the data regarding the number of wager requests for each pool can be updated via batch updating. In various embodiments, the bettor interface can be configured to access data from the intermediary computer regarding the number of wager requests currently placed in each pool at regular intervals and correspondingly display this intervally-updated information to the bettor. In any event, such information can be useful to a bettor in deciding which pool to place their wager request. For example, a bettor may be inclined to place their wager, or wagers, within the largest pools, i.e., the pools that currently have the largest number of wager requests contained therein. In various circumstances, as discussed above, the largest pools may provide a bettor with a larger winning probability than smaller pools, i.e., pools that have a lower number of wager requests contained therein.

In various embodiments, the number of wager requests that can be placed into a wager request pool can be fixed. In certain embodiments, a pool can be limited such that only a certain maximum number of wager requests can be placed in the pool. In at least one embodiment, the bettor display can be configured to access information stored on the intermediary computer, and/or any other suitable computer, regarding the maximum number of wager requests permitted for each fixed participation pool and, correspondingly, display this information to the bettor. In various circumstances, such information can be useful to a bettor in deciding which pool to place their wager request. For example, a bettor may be inclined to place their wager, or wagers, within the largest possible pools, i.e., the pools that have the largest number of wager requests permissible therein. In various circumstances, as discussed above, the largest possible pools may provide a bettor with a larger winning probability than pools having a smaller maximum number of wager requests. In any event, in various embodiments, the bettor interface can also be configured to display the current number of wager requests contained within the fixed participation pools. Once the maximum number of permissible wager requests within a pool has been reached, the intermediary can close the wager request pool and prevent additional wager requests from being placed into the wager request pool. The intermediary can then place a number of wagers equal to the maximum number of permissible wagers on the lottery designated by the wager request pool before the lottery drawing is held.

In various embodiments, as outlined above, the intermediary can offer a plurality of wager request pools, or groups, into which bettors can place one or more wager requests. In certain embodiments, further to the above, an intermediary can offer more than one pool for the same lottery. In at least one such embodiment, the intermediary can offer a plurality of pools each having a different maximum participation number for the same lottery. For example, the intermediary can offer a first pool having a first maximum participation number, such as 100 wager requests, for example, a second pool having a second maximum participation number, such as 200 wager requests, for example, a third pool having a third maximum participation number, such as 300 wager requests, for example, and so forth. In such embodiments, the maximum participation number for each pool can be viewed by the bettor via the bettor interface, for example, and, as a result, the bettor can selectively choose the pool, or pools, in which they would like to participate in.

With regard to fixed participation wager request pools, in various circumstances, the maximum number of permissible wager requests may not be reached. In such circumstances, each fixed participation pool can also include a time deadline wherein, upon reaching the time deadline, the intermediary can close the wager request pool and prevent additional wager requests from being placed in the wager request pool. At such point, in various embodiments, the number of wager requests within the pool can comprise the wager request pool count. The intermediary can then place a number of wagers equal to the wager request pool count on the lottery designated by the wager request pool before the lottery drawing is held. In certain embodiments, further to the above, the intermediary can participate in a wager request pool. In at least one such embodiment, the intermediary can participate in a wager request pool by placing as many wagers as necessary for the maximum number of wager requests of a fixed participation pool to be reached. In certain embodiments, the intermediary can participate in either a fixed participation wager request pool and/or an open-ended participation pool by placing as many wagers as necessary in order to reach a certain minimum number of wager requests within a pool. Such a minimum number can comprise 100 wager request, 200 wager requests, or 300 wager requests, for example. In certain circumstances, the intermediary can provide a guarantee to the bettors, or potential bettors, that the intermediary will participate within a wager request pool to reach a minimum number or a maximum number of wager requests, for example. In various embodiments, the intermediary can guarantee a minimum number and a maximum number of wager requests, or range of wager requests, within a pool.

As discussed above, an intermediary can offer pools whose final wager request count will fall within a certain range. Such a range could comprise a range between 10 wager requests and 100 wager requests, 100 wager requests and 200 wager requests, 100 wager requests and 500 wager requests, 100 wager requests and 1,000 wager requests, 100 wager requests and 10,000 wager requests, 1,000 wager requests and 10,000 wager requests, 100 wager requests and 100,000 wager requests, 1,000 wager requests and 100,000 wager requests, or 10,000 wager requests and 100,000 wager requests, for example. In various circumstances, a bettor may want to improve his odds by participating in a pool but may want to limit the pool size so as to influence his maximum possible payout.

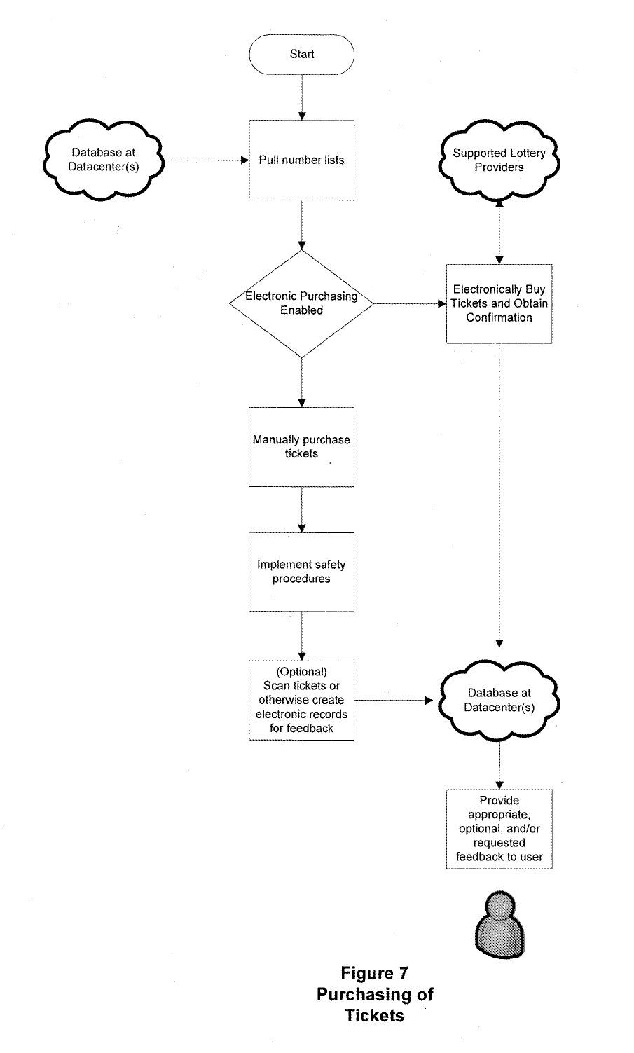

As discussed above, certain events can trigger the intermediary to place the amount of wager requests within a pool. These events can include a time deadline, a minimum number of wager requests being met, and/or a maximum number of wager requests being met, for example. In various circumstances, an intermediary can place the wagers for a wager request pool after the triggering event has occurred. In some circumstances, the intermediary can accumulate the wager requests during certain intervals and place the wagers at the end of each interval. In at least one such embodiment, for example, an intermediary can collect the wager requests made during each day and place a corresponding number of wagers at the end of that day. Other interval periods are also contemplated which are greater than or less than a day, such as every hour, every week, and/or every month, for example. In certain embodiments, the wager requests that are placed into a pool can be concurrently placed as wagers. In at least one such embodiment, a wager request can be placed as a wager immediately after it has been received. In any event, in various embodiments, the intermediary computer can place the wagers electronically, i.e., via wireless communication and/or wired communication, for example, with a lottery operator. In at least one such circumstance, the intermediary computer can communicate with a computer terminal operated by the lottery operator and/or a licensee authorized to conduct transactions on behalf of the lottery operator, for example. In certain other circumstances, the intermediary can physically travel to a lottery terminal operated by the lottery operator and/or a licensee authorized to conduct transactions on their behalf, for example, in order to place the wagers. In various circumstances, the intermediary can be a licensee authorized to conduct transactions on behalf of the lottery operator. In certain circumstances, the intermediary can be the lottery operator, such as a state, federal, and/or national government, or someone authorized to operate on their behalf, for example. In circumstances where an intermediary places one or more wagers and receives one or more tickets, referring to FIG. 7, the intermediary may hold the tickets until it is time to redeem the tickets with the lottery operator and/or their authorized licensee. In certain circumstances, the intermediary may electronically scan, and/or otherwise copy, one or more tickets and make the electronic scan of the ticket, or tickets, available to the bettors via the bettor interfaces, for example.

As described above, the number of wagers, w, placed for each wager pool can equal the number of wager requests, wr, contained within the pool. In various embodiments, each pool can be constructed and arranged such that sets of numbers selected for the wagers are selected when the wager requests are placed as wagers. In certain embodiments, the lottery operator, or the lottery operator terminal, can automatically select sets of numbers. In at least one embodiment, the sets of numbers can be randomly generated by a random number generator feature provided by the lottery operator terminal, for example. In various embodiments, the intermediary computer, and/or any other suitable computer, can comprise a random number generator, for example, which can be configured to randomly generate sets of numbers to be placed as wagers. In various embodiments, a pool can be constructed and arranged such that specific, or predetermined, sets of numbers are played when the wager requests are placed as wagers. In at least one embodiment, the bettor interface can be configured to access the intermediary computer, and/or any computer in which such sets of numbers are stored, and display such sets of numbers to the bettor. In certain embodiments, a pool of wager requests can be configured to play a set of numbers, or sets of numbers, which are statistically significant. More particularly, in at least one embodiment, the previous winning numbers of a particular lottery can be statistically evaluated to determine the most frequently-drawn numbers by the lottery and, accordingly, the set, or sets, of numbers selected for the wager request pool can be selected using those numbers. In at least one such embodiment, in lotteries where six numbers are drawn, a set of six numbers can be selected that uses the six most-drawn numbers for that lottery, for example. Alternatively, combinations of the seven most-drawn, eight most-drawn, nine most-drawn, ten most-drawn, eleven most-drawn, twelve most-drawn, thirteen most-drawn, fourteen most-drawn, and/or fifteen most-drawn numbers, for example, could be used to form the sets of six numbers that are placed as wagers. In certain embodiments, a set, or sets, of numbers can be selected that uses the least-drawn numbers for that lottery. For example, in lotteries where six numbers are drawn, the six least-drawn numbers could be used to form the set of six numbers. In addition to or in lieu of the above, combinations of the seven least-drawn, eight least-drawn, nine least-drawn, ten least-drawn, eleven least-drawn, twelve least-drawn, thirteen least-drawn, fourteen least-drawn, and/or fifteen least-drawn numbers, for example, could be used to form the sets of six numbers.

As described above, historical information regarding the numbers drawn, or least drawn, by a lottery can be used to determine the sets of numbers that are played when the wagers are placed for a wager request pool. In various embodiments, this historical information can be provided to and/or can be accessible by a bettor via their bettor interface, for example. In certain embodiments, a bettor may elect to utilize the historical information provided by the intermediary without participating in a wager request pool, or group. In at least one such embodiment, a bettor can place an individual wager, or wagers, by selecting a set, or sets, of numbers from the historical information provided by the intermediary. In various embodiments, the above-discussed historical information can include information regarding which numbers had been drawn most often over the entire history of the lottery, over a shorter period of time, and/or over a defined period of time, such as three months, six months, and/or one year, for example. Similarly, the above-discussed historical information can include information regarding which numbers had been drawn least often over the entire history of the lottery, over a shorter period of time, and/or over a defined period of time, such as three months, six months, and/or one year, for example. In certain embodiments, this historical information can include the date in which the numbers were last drawn, for example. In certain circumstances, certain numbers of a lottery will have been drawn more recently than others and a bettor may desire to derive a set of numbers to be played based on this information, for example. In other circumstances, certain numbers of a lottery will have been drawn less recently than others and a bettor may desire to derive a set of numbers to be played on this information, for example.

In various embodiments, further to the above, an intermediary can allow a bettor to create their own wager request pool. In at least one such embodiment, the bettor can select the set, or sets, of numbers that will be placed and allow other bettors to participate in that pool. In certain embodiments, the bettor can define certain characteristics of the pool such as the lottery in which the wagers will be placed and/or a maximum participation number, for example. In various embodiments, the information regarding the wager request pool can be stored on the intermediary computer, and/or any other suitable computer and/or device in signal communication with the intermediary computer. In at least one embodiment, the intermediary can permit a bettor to participate in groups of friends or acquaintances wherein the members of such groups can contact the other members and notify them of the wager request pools that they have created and/or are participating in, for example. In certain embodiments, the intermediary can provide one or more group members with certain administrative powers and/or software tools that could be utilized to administer the group. In various embodiments, the bettor can repeatedly use the same sets of numbers from drawing to drawing and/or use different sets of numbers from drawing to drawing.

In various embodiments, the intermediary can charge a fee for receiving wager requests and placing those wager requests as wagers. In certain embodiments, the intermediary fee can comprise a percentage of the wagered amount. In at least one embodiment, for example, a lottery ticket may be purchased for one dollar and the intermediary may charge a percentage of the lottery ticket cost, such as five percent, for example. In certain embodiments, the intermediary can charge a flat fee for placing a wager request regardless of the cost of the lottery ticket. In at least one embodiment, for example, an intermediary may charge $0.05 for every wager request regardless of whether the lottery ticket costs one dollar, two dollars, and/or any other amount, for example. These fee arrangements are exemplary and other fee arrangements may be possible. In various embodiments, a bettor's profile can include information regarding a bank account, debit card, credit card, PAYPAL® account, credit line, and/or any other suitable monetary source, for example, which can be drawn on when the wager request is placed. In certain embodiments, the wager requests can be placed using check disbursements, payroll deductions, and/or using reward points from a reward points system held by the intermediary, for example. In at least one such embodiment, reward points can be accumulated by a bettor for each wager request that they place and can be redeemed in exchange for being able to place free wager requests and/or access certain information, such as historical information regarding numbers drawn in certain lotteries, for example. In certain embodiments, such information can be stored on the intermediary computer and/or any other computer that can be accessed by the intermediary computer.

In various embodiments, further to the above, a third party could be utilized to bill the bettor and pay the intermediary for wager requests paid by the intermediary. In at least one such embodiment, a cell phone provider could bill a bettor placing a wager request via cell phone, collect the bill, and transmit the collected amount, or a portion of the collected amount, to the intermediary. In certain embodiments, an intermediary could utilize an account card program wherein the intermediary, for example, could issue an account card containing credits paid for in advance by the bettor and charge the card as the bettor places wager requests, for example. In various embodiments, the credits on the card could be rechargeable and, in certain embodiments, further to the below, any winning proceeds could be credited to the bettor's card, or account.

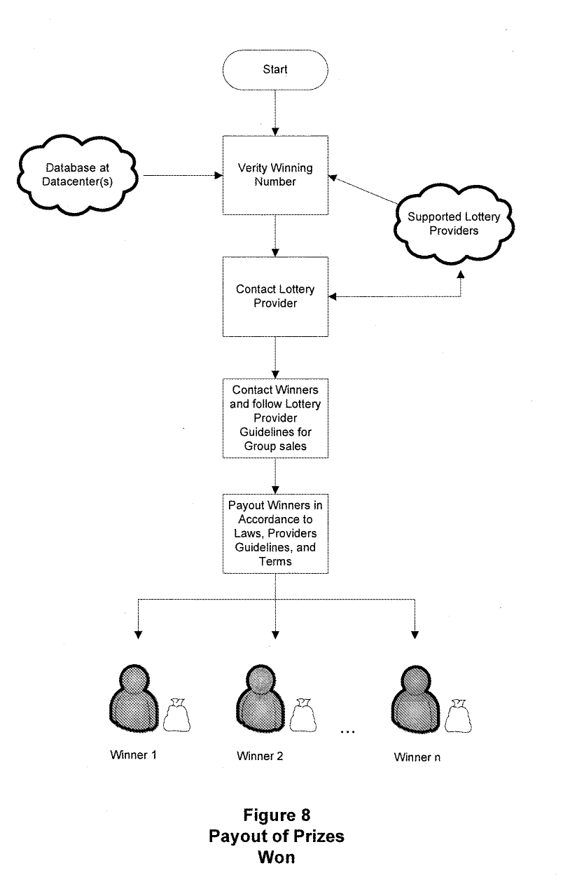

In various circumstances, wagers placed for the wager request pools may win a prize, or multiple prizes, from their respective lotteries. In various embodiments, the intermediary can electronically and/or physically redeem the lottery tickets with the lottery operator and/or a licensee authorized to act on the lottery operator's behalf. In embodiments where winning tickets can be electronically redeemed with a lottery operator, the proceeds of the winning tickets can be transferred to a bank account owned by the intermediary via an Electronic Funds Transfer (EFT), for example. In any event, referring to FIG. 8, the intermediary computer can be configured to divide and distribute the winning proceeds for each wager request pool amongst the bettor participants within the pools. In at least one such embodiment, for example, a first pool can win a first amount of winning proceeds, wp₁, and the first amount can be divided by the number of wager requests, wr₁, within the first pool and distributed to the bettors participating in the first pool based upon the number of wager requests that they placed in the first pool. For example, a bettor who placed one wager request in the first pool would receive an amount equal to wp₁/wr₁ while another bettor who placed n amount of wager requests in the first pool would receive an amount equal to n*(wp₁/wr₁). Similarly, a second pool can win a second amount of winning proceeds, wp₂, and the second amount can be divided by the number of wager requests, wr₂, within the second pool and distributed to the bettors participating in the second pool based upon the number of wager requests that they placed in the second pool. In various embodiments, the intermediary computer, and/or any other suitable computer in signal communication with the intermediary computer, can transfer the appropriate portion of the winning proceeds to a bank account, debit card, credit card, PAYPAL® account, credit line, and/or any other suitable account, for example, indicated in the bettor profile and/or the intermediary computer, for example.

In various embodiments, the intermediary can charge a fee that comprises a portion of the winning proceeds of a pool. In at least one such embodiment, the intermediary can retain a percentage of the winning proceeds, such as five percent, for example, before paying out the remainder of the winning proceeds. In certain embodiments, the intermediary can charge a flat fee per pool that is operated by the intermediary, for example. Regardless of the manner in which the fee is calculated, this fee can be subtracted from the winning proceeds, wp, before the remaining, or residual, winning proceeds are divided among the wager requests in the pool, as outlined above. In the various circumstances where the intermediary has participated in a wager request pool, as outlined above, the intermediary can retain a share of the residual winning proceeds which is proportional to the number of wager requests that the intermediary placed in the pool.

In various embodiments, a wager request pool can be configured and arranged to retain at least a portion, if not all, of the winning proceeds, less any intermediary fee, of the pool until the maximum prize, or any other particular prize, for a particular lottery has been won. Such a pool could be considered a perpetual pool as opposed to a pool which operates independently of any previous or subsequent drawing, for example.

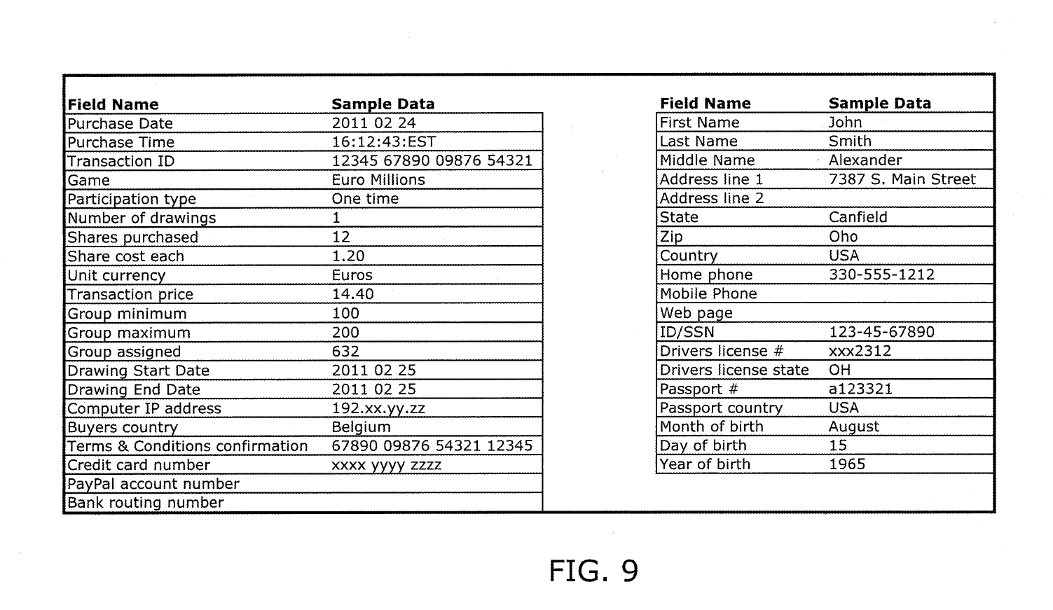

As discussed above, an intermediary can administer a plurality of wager request pools into which bettors can selectively place one or more wager requests. In order to manage the wager request pools, the intermediary computer, and/or any suitable computer or device in signal communication with the intermediary computer, can comprise a database which can store information regarding each wager request. Referring to FIG. 9, each wager request can be defined by a wager request entry in the database and can comprise the following information stored in various fields of the database: the wager request purchase, or transaction, date, a unique transaction identification associated with the wager request, the lottery or game in which the wager is to be placed, the number of wager requests, or shares, of the wager request pool, the cost of each wager request, and/or the currency in which the transaction is being conducted. Each database wager request entry can also include a description of the wager request pool, any pool minimum size, any pool maximum size, the lottery drawing start date and/or time, the lottery drawing end date and/or time, and/or any cut-off deadline. Each database wager request entry can also comprise the computer IP address and/or cell phone number from which the wager request transaction was made, the country from which the wager request was transmitted, and/or a confirmation code indicating that the bettor has a user agreement on file with the intermediary, for example. The database wager request entry can also comprise the bettor's name, the bettor's address(es), the bettor's phone number(s), the bettor's government identification number, driver's license number, passport number, and/or social security number, the bettor's citizenship, the bettor's birthday, the bettor's credit card number(s), the bettor's PAYPAL® account number(s), and/or the bettor's bank account and routing number(s), for example. In various embodiments, such information can be utilized to determine if the bettor is eligible to participate in the wager request pool and the lottery associated therewith. In various circumstances, the intermediary may verify, or require verification of, such information prior to participating in a wager request pool and/or distributing a portion of the winning proceeds to the group participants, for example. The database entry depicted in FIG. 9 is exemplary and any suitable form or format of database could be used to store, sort, and retrieve the data.

In various embodiments, further to the above, the intermediary computer, the bettor interface, and/or any other suitable computer can be configured to verify whether the bettor is old enough to participate in a particular lottery. In certain embodiments, the intermediary computer, for example, can be configured to cross-reference certain public records, such as utility records, property records, and/or any searchable records, for example. In any event, certain lotteries may require the bettors participating in a wager request pool to collect their winnings in person in the event that the pool wins certain prizes, such as the maximum prize, from the prize pool, for example.

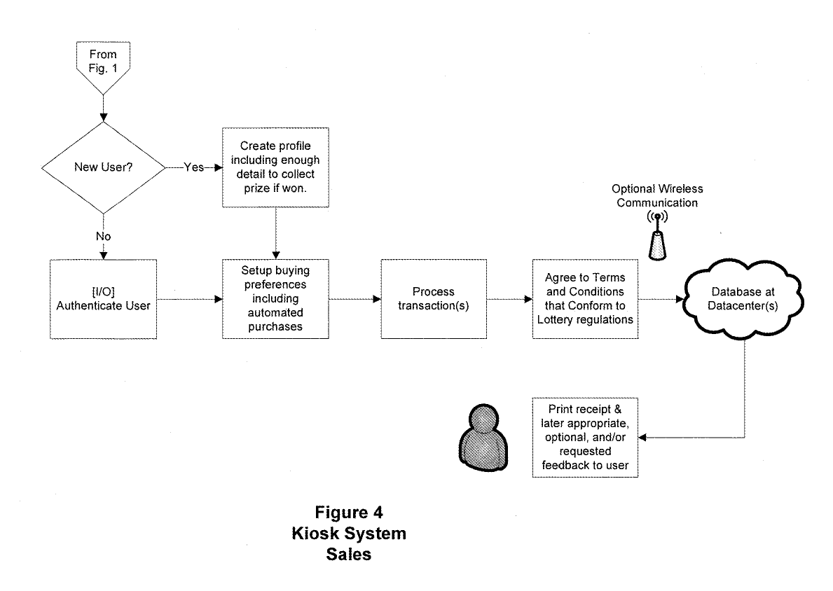

As described above, wager requests can be placed by a bettor using any suitable internet network, intranet network, telephone network, cellular phone network, and/or any other suitable network that allows a bettor to interface with one or more of the intermediary's computers and/or systems, for example. In various embodiments, referring to FIG. 4, the intermediary can operate one or more kiosks, for example, to which a bettor can travel to place their wager requests. In certain embodiments, the intermediary can provide any suitable means for identifying the bettor and accessing the bettor's profile. Once the bettor profile has been sufficiently accessed, the bettor's wager request can be completed as described herein. In various embodiments, a kiosk can be unmanned, i.e., a bettor can place a wager request without the assistance and/or presence of an intermediary representative. In certain other embodiments, a representative of the intermediary can be present at the kiosk to assist the bettor.

In various embodiments, as described above, a bettor can selectively participate in one or more pools being operated by the intermediary. In certain embodiments, the intermediary can allow a bettor to arrange for wager requests to be placed automatically according to a predefined set of criteria. In at least one such embodiment, a bettor can elect to have a certain number of wager requests be placed for each drawing of one or more predesignated lotteries. In certain embodiments, a bettor can elect to have a certain number of wager requests be placed if the largest prize of one or more predesignated lotteries exceeds a predetermined amount. In at least one embodiment, a bettor can elect to have the number of automatic wager requests be determined by the largest prize of a lottery. For example, a bettor can designate that one wager request should be placed if the maximum prize is less than or equal to a first amount, that two wager requests should be placed if the maximum prize is between the first amount and a second amount which is larger than the first amount, and that three wager requests should be placed if the maximum prize is between the second amount and a third amount which is larger than the second amount, for example. In certain embodiments, a bettor can designate that a wager request be placed on a certain date regardless of the lottery that it is placed on and/or regardless of the wager request pool that is placed into. In at least one such embodiment, a bettor may designate their birthday as the certain date, for example, and may specify that a certain set of numbers be placed as a wager on that date, for example.

In various embodiments, as discussed above, a bettor can select the number of wager requests that they can place into a wager request pool, or group. In various circumstances, as a result, they may place more wager requests or less wager requests than the other bettors participating in the pool and the amount in which they contribute to a pool may change from drawing to drawing or remain the same. In certain circumstances, a wager request pool may be constructed and arranged such that each bettor must place the same number of wager requests into a pool. In any event, the participation of additional, or subsequent, bettors in a wager request pool may cause the winning probability of the pool, and the bettors participating in the pool, to be dynamic. More particularly, a first bettor may place their wager request(s) into a pool and, at the time of that transaction, the bettor and the pool, or group, may have a first winning probability wherein the winning probability of the first bettor, and the pool, increases when a subsequent, or second, bettor places their wager requests into the pool. In such circumstances, the winning probability of a group can be dynamic, or change over time. A substantial benefit of such an arrangement is that the winning probability of a bettor can increase after they have placed their wager request(s). In various embodiments, it is envisioned that the wager requests within a pool, or group, could reach approximately 1,000, approximately 5,000, approximately 10,000, and/or approximately 25,000 wager requests, for example.

In various embodiments, the intermediary computer, for example, can comprise a feature which finds a suitable pool for a bettor. In at least one such embodiment, a bettor can establish at least one criterion, such as winning probability and/or maximum pool size, for example, from which the intermediary computer can attempt to match the bettor with one or more pools, for example. In certain embodiments, the bettor can place a floating wager request with the intermediary in which the wager request will be placed according to at least one criterion. In at least one such embodiment, the bettor can specify that their wager request be placed in the pool that has the highest winning probability for a lottery drawing on that day, for example.

In various embodiments, further to the above, a bettor can select the wager request pools, or groups, in which they participate in. In certain embodiments, the pools, or groups, can be constructed and arranged such that the participants in the pools are limited to a specific group of individuals. Stated another way, the list of participants who may participate in the group can be fixed. In other embodiments, the pools, or groups, can be constructed and arranged such that the participants in the pools can be dynamic, i.e., the participants in the group can change from drawing to drawing. In various circumstances, only a portion of the participant list may change from drawing to drawing; however, such a changing participation list would be dynamic. In various embodiments, bettors can place one or more wager requests into one or more pools without committing to placing any subsequent wager requests and/or without committing to placing wager requests on an on-going basis.

In various embodiments, as described above, the prize pool of a lottery can comprise one-time payouts of money, for example. In certain embodiments, the prize pool of a lottery can comprise periodic payments, such as annuity payments, for example. In such embodiments, the intermediary can collect such periodic payments on behalf of a wager request pool and distribute such payments to the bettors according to a schedule based on their share of the pool, or group, as described above. For example, a wager request pool can be configured and arranged to specify the dates or frequency in which any collected annuity payments will be distributed, such as monthly, quarterly, and/or yearly, for example. In various embodiments, the periodic distribution of the periodic payments can comprise the same time period as, or longer time periods than, the periodic payments from the lottery operator, for example. In at least one embodiment, yearly payments received from winning a lottery can be distributed yearly by the intermediary. In certain embodiments, the pool, or group, can receive and/or elect to receive one-time payouts from winning a lottery. In some embodiments, the pool, or group, can be configured and arranged to receive one-time payouts from a winning a lottery and distribute the winnings over a series of distributions to the bettors who participated in the pool. The terms for such an arrangement can be accessible to the bettors via the bettor interface. In certain embodiments, a bettor interface can be configured to display whether a wager request pool will take the option of one-time payouts or annuity payments, for example. In some embodiments, a wager request pool, or group, can permit each bettor in the group to select whether they want to receive their distribution as a one-time payout or over a series of payouts. In at least one such embodiment, as a result, a wager request pool, or group, may have participants who elect to receive their distribution as a one-time payout in addition to participants who elect to receive their distribution over a series of payouts.

As discussed above, the wagers of two or more bettors can be collected and placed into a pool, or group, of wagers wherein, in such circumstances, the presence of the wagers from multiple bettors in the same pool can improve the winning probability of each bettor within the pool. Stated another way, the inclusion of wagers by multiple bettors in the same pool increases the winning probability of the pool of wagers as a whole and, thus, increases the winning probability of each bettor who is participating in the pool. As a result, the winning probability of a pool, or group, is increased for not only a share of the maximum prize, but any lesser prizes as well. In various embodiments, a wager request pool can be structured and arranged to place wagers on more than one lottery. For example, a wager request pool can be configured to place a first quantity of wagers on a first lottery and a second quantity of wagers on a second lottery. Certain other wager request pools can be configured to place a quantity of wagers on more than two lotteries. In various circumstances, a wager request pool can be configured to place the same number of wagers on each of the lotteries played by the wager request pool while, in other circumstances, a wager request pool can be configured to place a different number of wagers on each of the lotteries played by the wager request pool, for example. In various embodiments, the wager request pool can be configured to divide, or allocate, the money within the wager request pool such that a first percentage of the money is allocated to place wagers on a first lottery and a second percentage of the money is allocated to place wagers on a second lottery, for example. In certain embodiments, the first percentage can be the same as the second percentage while, in certain other embodiments, the first percentage can be different than the second percentage.

In various embodiments, a wager request pool can comprise a portfolio of lottery wagers. In at least one embodiment, the portfolio can comprise lottery wagers placed on different lotteries, wherein some of the lottery wagers can have certain risk and return attributes while other lottery wagers can have different risk and return attributes. For instance, a first lottery wager in the portfolio can be placed on a first lottery having a potentially high rate of return, or gain, and, at the same time, a higher risk of having a negative investment return, or loss, wherein a second lottery wager can be placed on a second lottery having a potentially lower rate of return, or gain, and, at the same time, a lower risk of having a negative investment return, or loss. In various embodiments, a portfolio can comprise any suitable number of lottery wagers placed on any suitable number of lotteries having different risk and return attributes. In at least one embodiment, a lottery portfolio can include lottery wagers placed on at least one lottery in a first state and at least one lottery in a second state, for example. In various embodiments, any suitable number of lottery wagers can be placed on any suitable number of lotteries in any suitable number of jurisdictions, such as cities, states, and/or foreign countries, for example.

In various circumstances, as described above, a portfolio of lottery wagers can include wagers having a potentially higher payout and lower odds of winning and wagers having a potentially lower payout and higher odds of winning. In certain circumstances, a manager of a portfolio can analyze the risk and return attributes of wagers placed in several lotteries and decide the manner in which the money, or assets, within the wager pool should be allocated. In certain circumstances, the portfolio of a wager pool could be constructed to have an emphasis on achieving a high, or the highest possible, rate of return. In such an embodiment, the manager could place a large number of wagers on a lottery, or lotteries, having a large prize pool and/or large first prize, or jackpot. In some circumstances, the portfolio of a wager pool could be constructed to have an emphasis on achieving the greatest probability of a positive rate of return. In such an embodiment, the manager could place a large number of wagers on a lottery, or lotteries, having higher odds of participating in a lottery prize pool.

In certain embodiments, the number and types of lotteries that are played and the number and types of wagers that are placed on each of the lotteries can be selected so as to collectively provide a portfolio with desirable overall risk and return attributes. One model for selecting the desirable overall risk and return attributes of a portfolio can include the concept of the efficient frontier in modern portfolio theory. According to such a model, a combination of assets, i.e. a portfolio, is referred to as “efficient” if it has the best possible expected level of return for its level of risk (usually proxied by the standard deviation of the portfolio's return). This model is discussed in greater detail in Portfolio Selection: Efficient Diversification of Investments by Harry M. Markowitz, the entire disclosure of which is incorporated by reference herein. Alternatively, a portfolio can be efficient if it has the lowest possible risk for a given expected return. While these models may be utilized to arrive at desirable risk and return attributes for a portfolio of lottery wagers, other models could be utilized.

In various embodiments, the manager of the wager pool portfolio can evaluate the appropriate mix of lottery wagers which would achieve, or most closely achieve, the goals of the wager pool. In certain circumstances, the manager could evaluate several lotteries within a particular state, several lotteries within several different states, and/or several lotteries within several different countries and place wagers accordingly in order to achieve a desired allocation of risk and reward for the portfolio. In various embodiments, the portfolio manager could determine what numbers should be played in each of the lotteries utilizing historical information, as described above. In certain embodiments, only the portfolio manager, or their agents, would purchase and/or redeem the lottery tickets. In such embodiments, a participant in the wager pool would not select the numbers that are played in the lotteries and/or purchase the lottery tickets on behalf of the wager pool. Various alternative embodiments are contemplated in which a wager pool participant could select and/or manage, among other things, the lotteries to be played and/or the allocation of assets within the wager pool.

In various embodiments, a portfolio including lottery wagers can also include other types of investments. In certain embodiments, such a portfolio can include fixed income investments, municipal bonds, corporate bonds, United States Treasury bonds, stocks, and/or any other suitable type of financial instrument from any suitable issuer, for example. In at least one embodiment, a portfolio manager of wager pool can purchase such instruments to provide a lower-risk portion of their investment strategy. In various embodiments, the portfolio can include bonds which mature in thirty days or less and/or periods of time which are longer than thirty days, for example. In various circumstances, the portfolio manager can buy and sell such instruments, as desired, prior to the final payout of the wager pool. As outlined above, a portfolio of lottery wagers held by a wager pool can contain, one, wagers which are awarded a prize, or prizes, from a lottery prize pool when they win and, two, wagers which are not awarded a prize from a lottery prize pool when they lose. In various circumstances, the prizes that are won can be collected and distributed among the participants in the wager pool as part of a final payout of the wager pool, as described above. In at least one such embodiment, the prizes can be distributed after all of the lotteries being played by the wager pool have been completed.

In certain embodiments, a wager pool can be constructed such that at least a portion of the winnings can be retained by the pool. In at least one such embodiment, the winnings can then be used to place wagers on one or more lotteries and/or used to purchase other financial instruments, as appropriate. In various embodiments, such a wager pool may be perpetual or, in some embodiments, the terms of the wager pool can specify a triggering day and/or event which would cause at least a portion of the assets contained therein to be paid out to the wager pool participants. In certain embodiments, the terms of the wager pool can include a cash-out option in which a participant can withdraw all or part of their funds from the wager pool. In the event that a wager pool was structured to make annualized payments to a wager pool participant, in at least one embodiment, the present value of the annualized payments could be calculated, less any risk or cost associated discount, for example, and then paid to the departing wager pool participant. In the event that a wager pool included a maturing asset, in at least one embodiment, the present value of the maturing asset, or assets, could be calculated, less any risk or cost associated discount, for example, and then paid to the departing wager pool participant.

In various embodiments, as outlined above, the investments made in a lottery wager pool can be weighted in any suitable manner. In certain embodiments, a majority of the assets within the wager pool can be utilized to purchase lottery wagers. In various embodiments, at least 90% of the wager pool assets can be utilized to purchase lottery wagers, at least 80% of the wager pool assets can be utilized to purchase lottery wagers, at least 70% of the wager pool assets can be utilized to purchase lottery wagers, at least 60% of the wager pool assets can be utilized to purchase lottery wagers, and/or at least 50% of the wager pool assets can be utilized to purchase lottery wagers, for example. In at least one embodiment, a large portion of the wager pool assets may be placed in financial instruments other than lottery wagers. In certain embodiments, a majority of the wager pool assets may be placed in such financial instruments. In various embodiments, at least 90% of the wager pool assets can be utilized to purchase financial instruments other than lottery wagers, at least 80% of the wager pool assets can be utilized to purchase financial instruments other than lottery wagers, at least 70% of the wager pool assets can be utilized to purchase financial instruments other than lottery wagers, at least 60% of the wager pool assets can be utilized to purchase financial instruments other than lottery wagers, and/or at least 50% of the wager pool assets can be utilized to purchase financial instruments other than lottery wagers, for example. In at least one embodiment, a wager pool can be managed such that the assets of the wager pool are placed in lottery wagers and other financial instruments until a triggering event occurs, such as winning a first prize, a jackpot, and/or a large prize exceeding a certain amount, for example. Once such a triggering event occurs, the large prize, for example, can be paid to the wager pool participants while the other assets in the wager pool can be kept within the wager pool in order to continue the strategy defined by the wager pool. Alternatively, all of the wager pool assets can be paid out when such a triggering event occurs.

According to at least one model, the value of a lottery wager can equal the product of the prize amount that can be won by the wager and the probability of winning that prize. In lotteries having more than one prize that is winnable by a wager placed thereon, the value of the lottery wager can equal the summation of the products of the respective prize amounts and winning probabilities. Various wager pools can be constructed such that only lottery wagers having the highest values are placed. In certain embodiments, a wager pool can be constructed such that the value of the lottery wagers placed by the wager pool exceed a certain minimum value, for example. In various embodiments, further to the above, the value of the wager may comprise one factor, among other factors, which are considered in whether to place that wager on a lottery. In at least one such embodiment, the risk, or probability of losing, of a lottery wager can also be analyzed in order to select the lottery, or lotteries, in which to place a wager. In such an embodiment, the manager of the portfolio can select and place the lottery wagers such that average risk of the portfolio is at and/or below a certain level of risk, for example.

In various embodiments, a wager pool can be constructed and managed such that it can set aside all of, or at least a portion of, its assets until the first prize, jackpot, and/or any other large prize in a lottery, or lotteries, exceeds a predetermined amount. In such embodiments, the assets that have been set aside within the wager pool may then be used to place wagers in that lottery, or lotteries. In effect, the wager pool may comprise a springing wager pool. In certain embodiments, a wager pool can be constructed and managed such that it will set aside all of, or at least a portion of, its assets until the value of a wager placed in a lottery, or lotteries, exceeds a predetermined amount. Such a wager pool may also comprise a springing wager pool, for example. In various embodiments, a wager pool can be constructed and managed such that it will set aside all of, or at least a portion of, its assets until the amount of the assets to be played exceeds a predetermined or certain amount wherein, at such point, the wager pool can allocate such assets in one or more investments, such as lottery wagers, for example. In at least one such embodiment, such a wager pool can benefit from a larger number of lottery wagers that are played concurrently as described herein. In certain embodiments, the participant may not be afforded the opportunity to select which lotteries are played, the amounts played, and/or the dates in which they are played.

As discussed above, one or more events, whether scheduled or unscheduled, can trigger a payout from a wager pool. In various embodiments, the participants in a wager pool can share equally in the payout. In at least one such embodiment, a wager pool can comprise shares, or participation openings, which can be purchased by different participants, wherein the purchase price, or a portion of the purchase price, of the shares, or openings, can be placed in the wager pool as part of the wager pool assets. In certain embodiments, a single participant may be able to purchase more than one share, or opening, in a wager pool. In such embodiments, each participant would share in the payout from the wager pool according to the number of shares, or openings, that they have purchased.

In various embodiments, the participants in a wager pool may not receive equal amounts from a payout. In at least one such embodiment, a participant may be awarded a fractional share of a payout based on certain parameters. In certain embodiments, each participant's fractional share can be a function of one or more parameters such as, for example, the value of the assets that the participant has contributed to the wager pool, the number of times in which the participant has contributed assets to the wager pool, the frequency in which the participant has contributed assets to the wager pool, and/or the overall time in which the participant has participated in the wager pool. In certain embodiments, such parameters could be utilized to calculate a wager pool factor for each participant wherein the wager pool factor could determine the amount, or fraction, that each participant receives from a payout. For example, the wager pool factor could comprise a number between 0 and 1 wherein a participant having a wager pool factor of 1 would receive a full share, or fraction, of the payout without reduction whereas a participant having a wager pool factor of 0.5 would receive half of a full share, or fraction, of the payout. In such an embodiment, a participant having a wager pool factor of 0 would not participate in the payout or may only receive a minimum amount, for example. In various embodiments, the wager pool factor of each participant can change over time. In at least one such embodiment, the wager pool factor of each participant can be evaluated at the time of a payout, and/or at any other predetermined or certain time, in order to determine each participant's fractional share of the payout. In wager pools configured to have, or possibly have, more than one payout over time, a participant's fractional share of each payout can depend on their wager pool factor at the time in which each payout is made, for example. Thus, in at least one embodiment, a first participant's wager pool factor may increase between a first payout and a second payout, a second participant's wager pool factor may decrease between a first payout and a second payout, and a third participant's wager pool factor may not change between a first payout and a second payout, for example.

As outlined herein, a participant may directly participate in a wager pool. The participant can agree to the terms and conditions of a wager pool and can choose to place an amount of money, or assets, in the wager pool. In various embodiments, a participant may participate in a wager pool as the result of some other event. In at least one such embodiment, a purchaser of an item can be enrolled in a wager pool as a result of that purchase. For instance, a portion of the purchase price of an item can be placed in a wager pool on behalf of the purchaser such that the purchaser becomes a participant in the wager pool.

In various embodiments, further to the above, the purchaser of a video game, for example, can become a participant in a wager pool when at least a portion of the purchase price of the video game is directed to the wager pool. In certain embodiments, a video game can be structured and arranged such that a user, or player, of the video game can purchase virtual items and/or rights to be used in the video game using real money or assets. In such embodiments, at least a portion of the money spent on the virtual items and/or rights can be directed to a wager pool. In various circumstances, the video game can define a virtual world wherein the virtual items and/or rights purchased by the user can provide the user with privileges and/or advantages in that virtual world, for example. The portion of the purchase price for such virtual items and/or rights that is directed to a wager pool can provide an incentive for the player of the video game to purchase such virtual items and/or rights, for example. In certain embodiments, the entirety of the purchase price for such virtual items and/or rights could be directed to one or more wager pools, for example. In some embodiments, at least a portion of the purchase price for such virtual items and/or rights could be directed to one or more portfolios of investments which can include fixed income investments, municipal bonds, corporate bonds, United States Treasury bonds, stocks, and/or any other suitable type of financial instrument from any suitable issuer, in addition to or in lieu of lottery wagers, for example. In certain embodiments, the video game can be distributed free of charge to the users, or players, wherein, in at least one such embodiment, at least a portion of the purchase price for the virtual items and/or rights within the video game could be directed to one or more portfolios of investments. In certain other embodiments, the users of the video game may be required to purchase the game; however, the users may earn virtual items and/or rights by playing the game and, in at least one embodiment, the earning of such virtual items and/or rights in the video game can result in the actual participation of the user in a wager pool, for example. A video game, as described herein, can comprise software configured and/or otherwise programmed to be played on one or more computers in which one or more users, or players, can participate in the video game. A computer, as used herein, can comprise any suitable electronic device, such as a desktop computer, a laptop computer, a hand-held device, and/or a cellular phone, for example. In various embodiments, the video game can include a user interface in which the virtual items and/or rights can be purchased. This user interface can also be configured to access and/or display information regarding the wager pool and/or convey whether the player has received or is entitled to receive any winnings from the wager pool.

In certain embodiments, further to the above, the gameplay of the video game can include an event, or events, in which the player can purchase a lottery ticket and/or otherwise invest virtual money and/or virtual assets in the video game, for example. A virtual event can be correlated with an actual event wherein the performance of the virtual event can trigger the actual event. In at least one embodiment, the virtual purchase of a lottery ticket, for example, can result in the player's actual participation in a lottery wager pool, for example. In at least one such embodiment, the amount of the virtual purchase can be correlated with the amount of the actual purchase. Such correlation can be one virtual dollar for one actual dollar, for example, or any other suitable correlation. In certain embodiments, an actual event can be correlated with a virtual event wherein the performance of the actual event can trigger the virtual event. In at least one embodiment, the player's actual participation in a wager pool, for example, can result in the player's virtual participation in a lottery wager pool, for example. In at least one such embodiment, the amount of the actual purchase can be correlated with the amount of the virtual purchase. In certain other embodiments, the performance of a particular virtual event within the video game can be correlated with an actual event wherein the performance of the virtual event can trigger the actual event. Similarly, the performance of a particular actual event can be correlated with a virtual event within a video game wherein the performance of the actual event can trigger the virtual event. In certain embodiments, the virtual acts performed by one user of the video game can result in an actual event which impacts that user and/or any other user of the video game. In certain embodiments, certain actual events unrelated to a user's behavior can trigger certain virtual events in the video game. For instance, when the S&P 500 stock index goes above and/or below predetermined or certain levels, for example, such events can trigger virtual events in the video game. In addition to or in lieu of a stock index triggering virtual events, other events, such as the movement of currency exchange rates, unemployment rates, and/or other world events can trigger virtual events in the video game. In some circumstances, the triggered virtual events in the video game can discourage the users from performing certain events which would result in the users participating in a wager pool, for example.

While the embodiments disclosed herein are described in connection with a lottery, as described above, the principles described herein are equally applicable to other games of chance. In various circumstances, the probability of a bettor winning a prize in various games of chance can be increased when their wager is placed as part of a larger pool of wagers. Such games of chance can include baccarat, craps, roulette, slots, bingo, sic bo, keno, and/or video poker, for example. Similarly, the probability of a bettor winning a prize in other games which may at least partially include skill, such as poker and/or black jack, for example, can be increased when their wager is placed as part of a larger pool or wagers. The invention described herein is inclusive of such other games of chance and/or skill. The details of such other games are not discussed at length in this application but are incorporated by reference herein.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of operating a wager pool comprising the steps of:
receiving assets from participants in the wager pool;
placing the assets in a portfolio of investments comprising a first investment and a second investment, wherein the first investment comprises at least one lottery wager, wherein the first investment comprises a first set of risk and reward attributes, and wherein the second investment comprises a second set of risk and reward attributes; and
allocating a first amount of the assets in the first investment and a second amount of the assets in the second investment to arrive at a desirable set of overall risk and reward attributes for the portfolio.

2. The method of claim 1, wherein said allocating step comprises determining the first amount of the assets and the second amount of the assets such that the potential overall reward for the portfolio is optimized for a given overall risk for the portfolio.

3. The method of claim 1, wherein said allocating step comprises determining the first amount of the assets and the second amount of the assets such that the potential overall risk for the portfolio is optimized for a given overall return for the portfolio.

4. The method of claim 1, further comprising the step of distributing assets from the wager pool after a triggering event.

5. The method of claim 4, wherein the triggering event occurs when one of the lottery wagers wins a first prize in a lottery.

6. The method of claim 4, wherein the triggering event occurs when the value of the assets in the portfolio exceeds a predetermined amount.

7. The method of claim 4, wherein the triggering even occurs when the number of participants in the wager pool exceeds a predetermined amount.

8. The method of claim 1, further comprising the step of holding the wager pool open for new participants.

9. A method of operating a wager pool comprising the steps of:
receiving assets from participants in the wager pool;
placing the assets in a portfolio of investments comprising at least one investment;
holding a portion of the assets in the portfolio until a lottery wager can be placed in a lottery having a desirable set of risk and reward attributes; and
placing the lottery wager with the held portion of the assets.

10. The method of claim 9, further comprising the step of allocating the assets between the at least one investment and the held portion of the assets to arrive at a desirable set of overall risk and reward attributes for the portfolio, wherein the overall reward for the portfolio is optimized for a given overall risk for the portfolio.

11. The method of claim 8, further comprising the step of allocating the assets between the at least one investment and the held portion of the assets to arrive at a desirable set of overall risk and reward attributes for the portfolio, wherein the overall risk for the portfolio is optimized for a given overall reward for the portfolio.

12. The method of claim 8, further comprising the step of distributing assets from the wager pool after a triggering event.

13. The method of claim 12, wherein the triggering event occurs when one of any lottery wager wins a first prize in the lottery.

14. The method of claim 12, wherein the triggering event occurs when the value of the assets in the portfolio exceeds a predetermined amount.

15. The method of claim 12, wherein the triggering event occurs when:
the value of the assets falls below a predetermined amount;
the at least one investment reaches a maturity date; or
one of the participants withdraws from the wager pool.

16. A method of operating a wager pool comprising the steps of:
receiving assets from a first participant and a second participant in the wager pool;
placing the assets in a portfolio of investments comprising at least one lottery wager;
assigning a first participation factor to the first participant;
assigning a second participation factor to the second participant;
determining an asset amount to be paid out from the wager pool;
determining a first amount to be paid to the first participant based on the first participation factor and the asset amount; and
determining a second amount to be paid to the second participant based on the second participation factor and the asset amount.

17. The method of claim 16, wherein said step of assigning the first participation factor to the first participant comprises calculating the first participation factor, and wherein said step of assigning the second participation factor to the second participant comprises calculating the second participation factor.

18. The method of claim 16, wherein said step of determining the first amount comprises the step of multiplying the first participation factor and the asset amount, and wherein said step of determining the second amount comprises the step of multiplying the second participation factor and the asset amount.

19. The method of claim 16, wherein said step of determining an asset amount to be paid out from the wager pool comprises the step of collecting a first prize from a lottery.

20. The method of claim 16, wherein said step of determining an asset amount to be paid out from the wager pool comprises the step of waiting for any maturing portion of the portfolio to mature.

21. The method of claim 16, wherein said step of determining an asset amount to be paid out from the wager pool comprises the step of selling any unmatured investments.

22. The method of claim 16, wherein said step of determining an asset amount to be paid out from the wager pool comprises the step of paying out less than all of the assets in the wager pool.

23. The method of claim 16, wherein said step of determining an asset amount to be paid out from the wager pool comprises the step of paying out all of the assets in the wager pool.
